(19) United States
(12) Patent Application Publication
(10) Pub. No.: US 2008/0097956 A1
(43) Pub. Date: Apr. 24, 2008

(54) Transmission device, transmission device setting system, and transmission device setting method and program

(75) Inventor: MASANAO AMIMOTO, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/907,875

(22) Filed: Oct. 18, 2007

(30) Foreign Application Priority Data
Oct. 20, 2006 (JP) 2006-286585

(51) Int. Cl. G06F 17/30

(52) U.S. Cl. 707/1; 707/E17.001

(57) ABSTRACT

A transmission device 100 stores a plurality of sets of setting data in a backup area 103 thereof, and uses any setting data in response to a command from an external terminal 200 to start up the own device. Accordingly, the user can automatically register a desired device configuration solely by selecting a device mode.

This application is based upon and claims the benefit of priority from Japanese paten application No. 2006-286585, filed on Oct. 20, 2006, the disclosure of which is incorporated herein in its entirety by reference.

### BACKGROUND OF THE INVENTION

The present invention pertains to a setting technique for changing a transmission device to the configuration state of a target device mode.

### DESCRIPTION OF RELATED ART

In changing a backbone transmission device to the configuration state of a target device mode, after start-up of the device at the initial state, it is needed for the user to select a command on an external terminal to carry out setting. Particularly, transmission devices require more complex setting operations than other general information processing devices.

The transmission device has configuration management data corresponding to the initial state of the device. In the data, many setting items are not preliminarily registered, including such as registration of packages mounted in the device, setting for allowing access between devices or from the outside of the device, and login registration. Accordingly, the user carries out setting during construction of the transmission device by checking a parameter sheet.

However, according to this method, the user carries out setting manually during construction of the transmission device by checking a parameter sheet, so it takes considerable time to carry out setting; and when a setting mistake happens, the previous setting cannot be cancelled, and thus the device must be restored to the initial state again to perform resetting. Consequently, start-up of the transmission device may not be completed within the planned on-site adjustment schedule, thus causing inconvenience to end users.

As the related art, Japanese Patent Application Laid-Open No. 03-080734 (Patent Document 1) has proposed a technique for selectively activating a plurality of control programs stored in storage units, the technique including: a plurality of storage units which stores a control program for a program stored-type communication processing device connected to a host information processing device; a selection unit which selects one from among the plurality of storage units and defines the selected one as the principal storage; and a unit which gives a selection command to this selection unit and thereafter activates an initialization processing.

Also, as the related art, Japanese Patent Application Laid-Open No. 05-022410 (Patent Document 2) has proposed a technique including a station data saving processing part, a station data area management part and a backup file; according to the technique, the backup file includes a station data management area and a plurality of station data areas storing station variable data, and the station data saving processing part activates the station data area management part in response to designation of station data or instruction of saving without designation, and when station data is designated, saves memory information in the corresponding station data area of the backup file, or when station data is not designated, detects the oldest station data area based on information in the station data management area and saves memory information, whereby the debug test of an exchanger system, the saving of station variable data in a current station, and the management of an IPL, can be efficiently managed without error.

Also, as the related art, Japanese Patent Application Laid-Open No. 06-006863 (Patent Document 3) has proposed a technique by which a plurality of slave stations are linked communicably via a communication path to a master station, and each slave station registers a parameter sent from the master station with an internal memory thereof, and each station reads from the internal memory, parameter data corresponding to a parameter number sent from the master station to set operating environment, whereby a master-slave network system is provided in which setting of parameters and setting modification in each terminal device linked to the system can be easily performed.

Problems with the above related arts will now be described.

When command setting is carried out by the user from an external terminal, the occurrence of a setting mistake may not be noticed depending on the level of user; consequently, the operating state starts as it is, and a problem may occur during operation.

Further, many man-hours for on-site adjustment are required during construction of a transmission device; and the number of evaluation items starting with the initial state cannot be reduced in in-house development evaluations and evaluations before shipment.

In many cases, the device mode of transmission device is changed according to the loss in transmission line during operation, and thus every time the device data state must be restored to the initial state to allow the user to carry out setting manually.

Further, users think that transmission device is a device that requires complex setting operations, and may have a negative image on the operability of transmission device; this may hinders strengthening of competitiveness.

### SUMMARY OF THE INVENTION

An exemplary object of the present invention is to provide a transmission device, a transmission device setting system, and a transmission device setting method and program, by which the user can automatically register a desired device configuration solely by selecting a device mode.

### [Transmission Device]

To achieve the above object, a transmission device according to an exemplary aspect of the present invention stores a plurality of sets of setting data in a storage area thereof, and uses any setting data in response to a command from a terminal to start up the own device.

A transmission device according to an exemplary aspect of the present invention has data for device mode management in addition to a master user data file, holds data files for each device mode, produces data files for each device mode before shipment based on a parameter sheet preliminarily acquired, copies onto the master data file, data being set in the user data file corresponding to a device mode, in response to a command from a terminal after a user selects a target device mode in constructing the device, to start up the own device by use of the data.

### [Transmission Device Setting System]

In a transmission device setting system according to an exemplary aspect of the present invention, a transmission device stores a plurality of sets of setting data in a storage area thereof, and uses any setting data in response to a command from a terminal to start up the own device.

In a transmission device setting system according to an exemplary aspect of the present invention, a transmission device has data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

### [Transmission Device Setting Method]

According to a transmission device setting method according to an exemplary aspect of the present invention, a transmission device stores a plurality of sets of setting data in a storage area thereof, and uses any setting data in response to a command from a terminal to start up the own device.

According to a transmission device setting method according to an exemplary aspect of the present invention, a transmission device has data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

### [Program]

A program according to an exemplary aspect of the present invention causes a computer to store a plurality of sets of setting data in a storage area thereof, and to use any setting data in response to a command from a terminal to start up the own device.

A program according to an exemplary aspect of the present invention causes a computer to have data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

### BRIEF DESCRIPTION OF THE DRAWINGS

The objects and features of the present invention will become more apparent from the consideration of the following detailed description taken in conjunction with the accompanying drawings, in which:

FIG. 1 is a view for explaining an approach to implement a pre-installation model by data management for each user in a transmission device setting system according to a first exemplary embodiment of the present invention;

FIG. 2 is a block diagram illustrating a configuration of the transmission device setting system according to the first exemplary embodiment of the present invention;

FIG. 3 is a view illustrating the transmission device after restart according to the first exemplary embodiment of the present invention;

FIG. 4 is a view for explaining the processing operation according to the first exemplary embodiment of the present invention; and

FIG. 5 is a block diagram illustrating a configuration of a transmission device setting system according to a second exemplary embodiment of the present invention.

### DESCRIPTION OF EXEMPLARY EMBODIMENTS

The present invention will be described in detail below with reference to the drawings illustrating a first exemplary embodiment thereof. It is noted that the same reference numerals denote identical parts in the drawings.

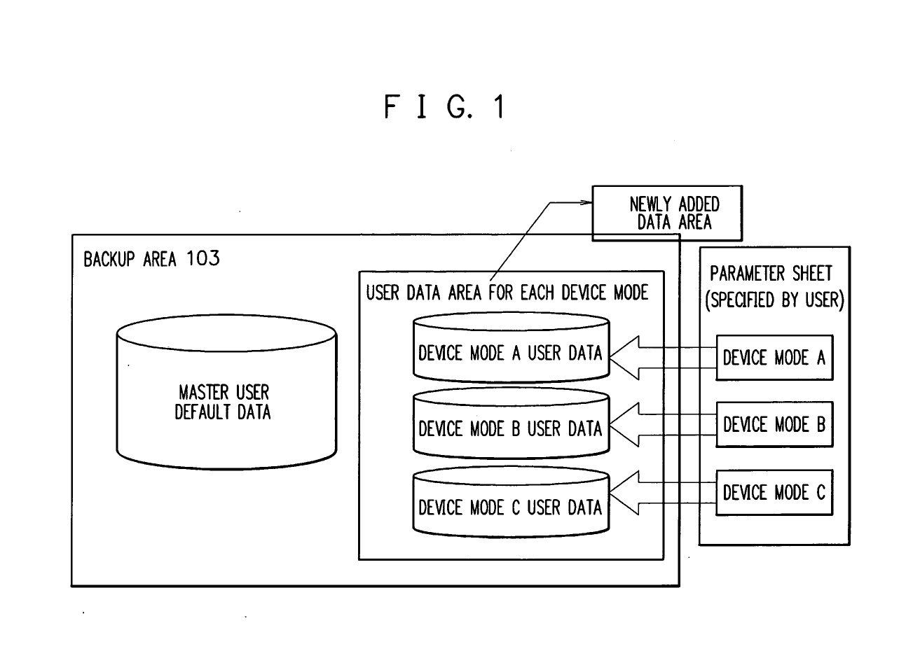

First, a method of implementing: a pre-installation model by data management for each user according to the present embodiment will be described with reference to FIG. 1. Data for device mode management is added to a master user data file, and data files are prepared for each device mode.

Data files for each device mode are produced before shipment based on parameter sheets acquired from clients, and thereafter transmission devices are shipped.

Data being set in a user data file corresponding to a device mode is copied onto the master data file at the timing when the user selects the target device mode in constructing the transmission device, and the transmission device is started up by use of the data, whereby start-up can be implemented with the data on the target device mode being set in the transmission device.

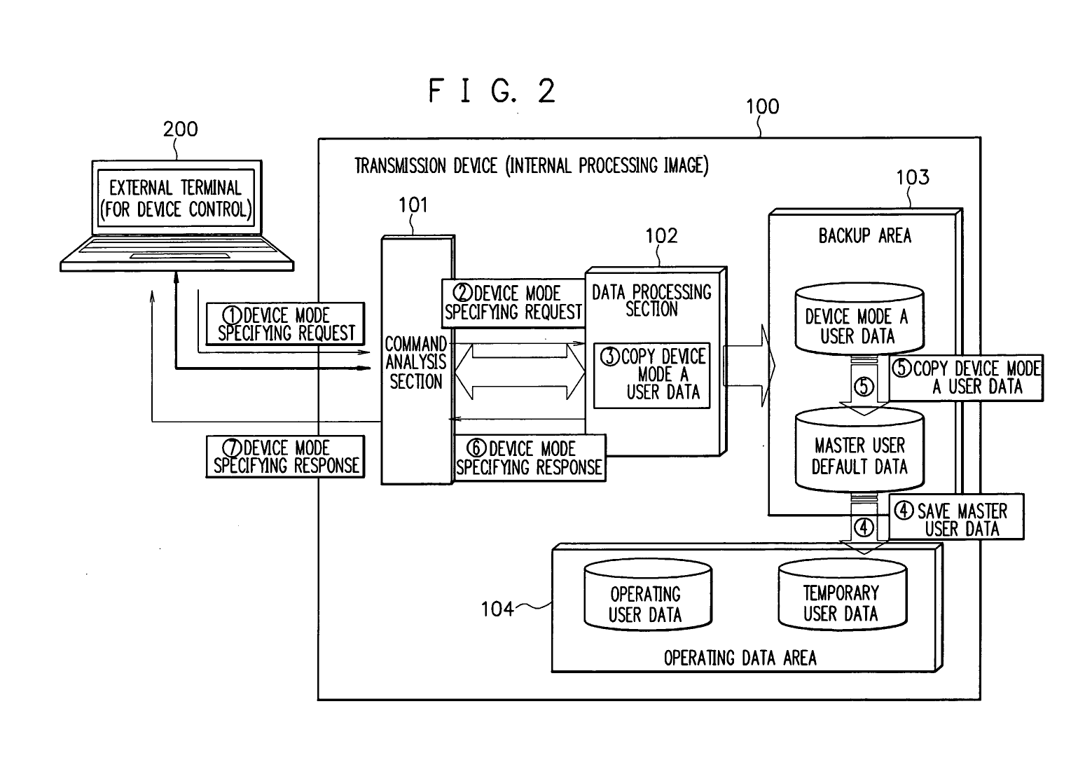

A configuration of a transmission device setting system according to the present embodiment will be described with reference to FIG. 2. The system includes: a transmission device 100 that controls optical transmission; a command analysis section 101 that controls a target device; a data processing section 102 that processes control data; a backup area 103 that backs up control data; an operating data area 104 that stores control data during operation; and an external terminal 200 that issues a device control command.

These sections execute respective operations described below.

The transmission device 100 that controls optical transmission is a device that wavelength-division-multiplexes, for example, forty optical waves of 2.4 GHz or 10 GHz and controls optical transmission over several hundred kilometers.

The external terminal 200 is provided with GUI by which the user controls and monitors the transmission device. The command analysis section 101 converts a command received from the external terminal 200 into a command format used in the device, or converts a response to be sent to the external terminal 200 into an external format.

The command data processing section 102 analyzes a command content received from the command analysis section 101 and executes a processing according to the analyzed content.

The backup area 103 holds data needed for controlling a transmission device in its ROM area. The data is used for data restoration during start-up of the device.

The operating data area 104 holds control data to be used by the transmission device during operation in its RAM area.

The structure of a pre-installation model will be described below.

GUI for device mode selection is prepared in the external terminal 200. At a time when the user selects device mode A on GUI and depresses an execution button, a device mode specifying request is sent to the transmission device 100 (the command analysis section 101).

The command analysis section 101 converts the received command into an internal format and sends it to the data processing section 102.

The data processing section 102 analyses the command content received from the command analysis section 101 and selects data of device mode A from the backup area 103. After master user default data is saved into temporary user data of the operating data area 104, the user data of device mode A is copied onto the user default data. After completion of the copying, the data processing section 102 sends a device mode specifying response via the command analysis section 101 to the external terminal 200.

The user checks on GUI whether or not data of device mode A are acceptable. If not, the data saved into the temporary user data area of the operating data area 104 is copied onto the master user default data of the backup area 103, whereby the data is restored to the previous state.

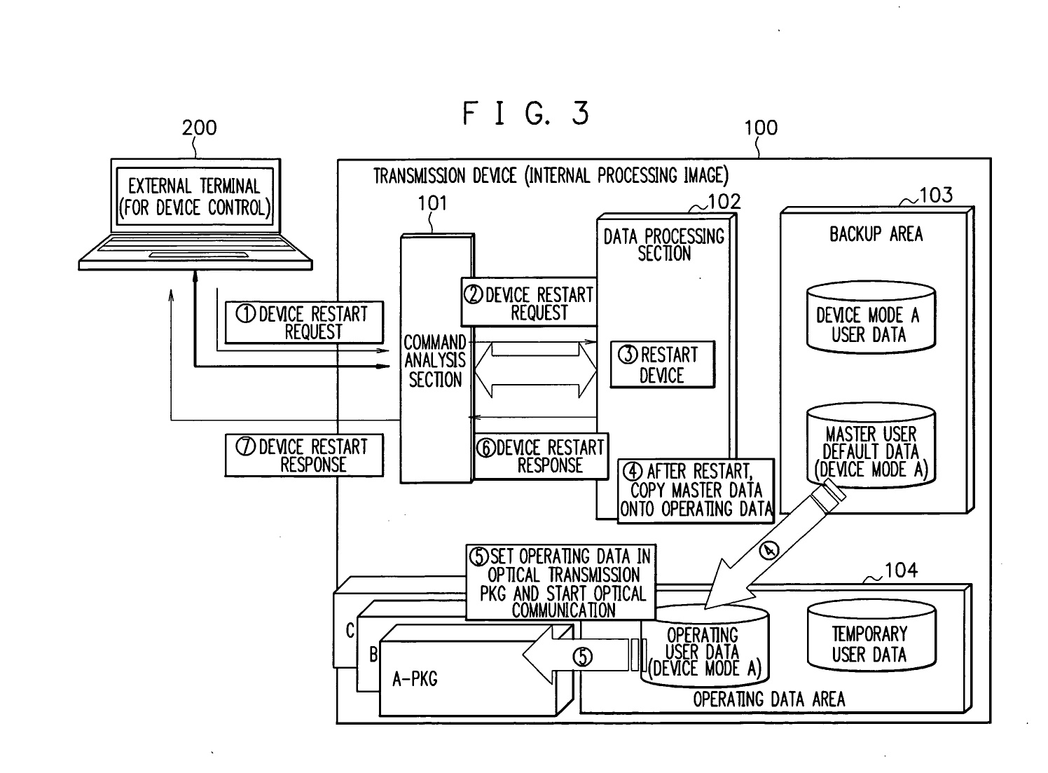

Subsequently, as illustrated in FIG. 3, the user depresses an OK button, so that a device restart request is sent to the transmission device 100; the request is sent via the command analysis section 101 to the data processing section 102 to restart the device.

After the restart, the data processing section 102 copies the master data of the backup area 103 onto operating data of the operating data area 104.

When the operating data of the operating data area 104 is set in optical transmission PKGs (A-PKG, B-PKG, C-PKG), optical transmission starts.

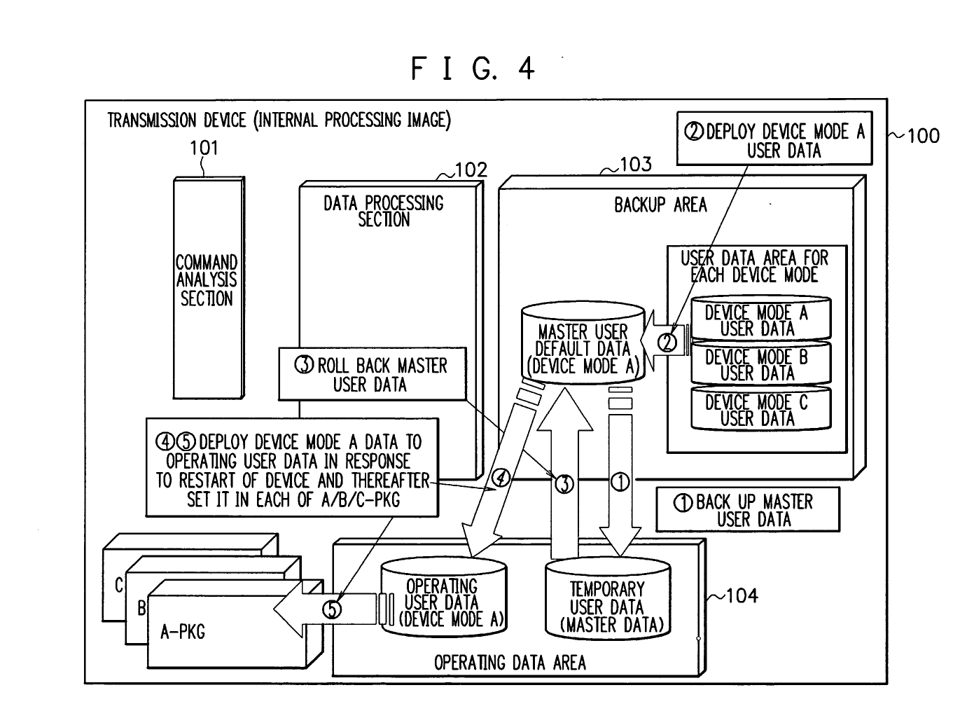

The entire operation according to the present embodiment will be described in detail with reference to FIG. 4.

The backup area 103 includes a master user data area and a user data management area for each device mode. The user data management area for each device mode contains device mode A user data, device mode B user data, and device mode C user data.

The operating data area 104 includes an operating user data area and a temporary user data area.

When device mode A is selected, the master user data is saved in the temporary user data area of the operating data area 104, then device mode A user data of the backup area 103 is copied onto the master user data area. In this case, when it is required to roll the device back to the original state due to occurrence of an operation error, a roll-back command is executed, so that the temporary user data of the operating data area 104 is copied onto the master user data area of the backup area 103 to restore.

If the device mode is selected correctly, the device is restarted, and the master user data of the backup area 103 is copied onto the operating user data of the operating data area 104 and then set in A-PKG, B-PKG and C-PKG, whereby optical transmission starts.

According to the present embodiment described above, data to be set for each device mode are determined before shipment based on parameter sheets acquired from users, so the setting data is set before shipment into the user data for each device mode of the backup area 103. Accordingly, when entering the local building, the user can know which device modes have been set in the shipped transmission device, and can thus select a device mode during device construction and start up the device at the target device mode. Consequently, the number of man-hours during device construction can be reduced; and while setting of the transmission device is complicated, setting mistake by the user can be prevented and thus operations under an improper state can be avoided. Furthermore, since pre-install is carried out before shipment, it is possible to charge the user with extra fees. Naturally, the number of evaluation items starting with the initial state can be reduced in in-house development evaluations and evaluations before shipment, thus allowing for reduction in man-hours for evaluation and evaluation period.

In many cases, the device mode of the transmission device is changed according to the loss in transmission line during operation, and thus every time the device data state must be restored to the initial state to allow the user to carry out setting manually. However, according to the present approach, it becomes possible to change to data of a new device mode solely by selecting the new device mode and restarting the device. Accordingly, during changing of device mode, the effect similar to during device installation can be achieved.

Also, while users think that transmission device is a device which requires complex setting, according to the present embodiment, the basic setting is completed by selecting a device mode and restarting the device, and thus the user's image on the operability of the transmission device can be improved, and strengthening of competitiveness of the product is also possible.

Also, even when data is lost during operation, since the previous data has been automatically backed before occurrence of the loss, the operation data can be easily restored.

The present invention will be described with reference to the drawings illustrating a second exemplary embodiment thereof.

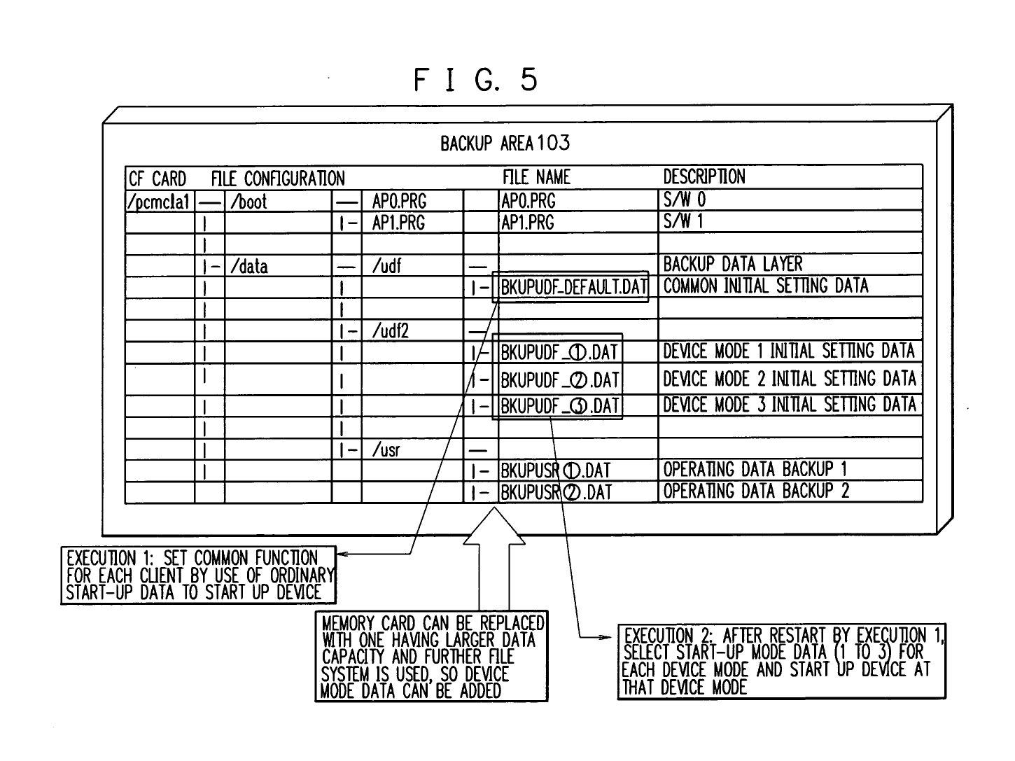

Referring to FIG. 5, since the backup area is provided with a file system, the number of user data for each device mode is not fixed at three, and data for each user are held separately, whereby the user data of a target device mode of a specified user can be selected. Thus, even if different setting data are requested for each user, starting up can be carried out with the desired device data by adding files for the users.

For example, the functions of the transmission device 100 and external terminal 200 may be implemented by loading into respective devices, programs for implementing those functions and executing the programs. Further, the programs may be transmitted to another computer via CD-ROM, magneto optical disk or the like being a computer-readable recording medium, or by use of transmission wave through the Internet, telephone line or the like being a transmission medium.

The previous descriptions are of embodiments where the configuration is used in which the transmission device 100 and external terminal 200 are constructed as a single computer system. However, needless to say, the present invention is applicable to a configuration in which multiple devices are provided for each function.

The effects of the present invention include the following: (1) the user can construct the transmission device without loading setting data, so that reduction of man-hours for user operation and prevention of occurrence of mistakes during data loading are possible, avoiding an operation under an improper state; (2) in changing the transmission device to another device configuration during operation, when a target device mode is selected using a nearby terminal connected to the transmission device, setting can be carried out at the selected device mode, and thus during changing of device mode, the effect similar to during device installation can be achieved; (3) the number of evaluation items starting with the initial state can be reduced in in-house development evaluations and evaluations before shipment, thus allowing for reduction in man-hours for evaluation and evaluation period; (4) setting is completed by an easy operation and thus the user's image on the operability of the transmission device can be improved, and strengthening of competitiveness of the product is also possible.

The previous descriptions are of preferred embodiments for implementing the present invention, and many modifications to the embodiments described above are possible without departing from the gist of the invention.

What is claimed is:

1. A transmission device that stores a plurality of sets of setting data in a storage area thereof, and uses any setting data in response to a command from a terminal to start up the own device.

2. A transmission device that has data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

3. The transmission device according to claim 1, wherein the setting data is stored by a file system.

4. A transmission device setting system in which a transmission device stores a plurality of sets of setting data in a storage area thereof, and uses any setting data in response to a command from a terminal to start up the own device.

5. A transmission device setting system in which a transmission device has data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

6. The transmission device setting system according to claim 4, wherein the transmission device stores the setting data by use of a file system.

7. A transmission device setting method by which a transmission device stores a plurality of sets of setting data in a storage area thereof, and uses any setting data in response to a command from a terminal to start up the own device.

8. A transmission device setting method by which a transmission device has data for device mode management in addition to a master user data file, holds data files for each device mode, produces before shipment, data files for each device mode based on a parameter sheet preliminarily acquired, copies onto the master data file, data being set in the user data file corresponding to a device mode, in response to a command from a terminal after a user selects a target device mode in constructing the device, to start up the own device by use of the data.

9. The transmission device setting method according to claim 7, wherein the transmission device stores the setting data by use of a file system.

10. A storage medium for storing a program that causes a computer to store a plurality of sets of setting data in a storage area thereof, and to use any setting data in response to a command from a terminal to start up the own device.

11. A storage medium for storing a program that causes a computer to have data for device mode management in addition to a master user data file, hold data files for each device mode, produce before shipment, data files for each device mode based on a parameter sheet preliminarily acquired, copy onto the master data file, data being set in the user data file corresponding to a device mode, in response to a command from a terminal after a user selects a target device mode in constructing the device, to start up the own device by use of the data.

12. A storage medium for storing the program according to claim 10, which uses the setting data stored by a file system.
